(19) United States
(12) Patent Application Publication
(10) Pub. No.: US 2026/0264119 A1
(43) Pub. Date: Sep. 10, 2026

(54) TANK CLEANER AND NOZZLE DEVICE

(71) Applicant: GEA Tuchenhagen GmbH, Buchen (DE)

(72) Inventor: Hans-Ludvig Skjong, Valderoya (NO)

(21) Appl. No.: 19/546,697

(22) Filed: Feb. 23, 2026

(30) Foreign Application Priority Data
Mar. 6, 2025 (DE) 102025108580.3

(51) Int. Cl. B08B 9/093; B05B 3/02

(52) U.S. Cl. CPC B08B 9/0936; B05B 3/028

(57) ABSTRACT

A tank cleaner comprising a static body configured to receive a cleaning fluid, a rotating body rotatable about a main axis of rotation mounted on the static body, a nozzle carrier rotatable about a sub-axis of rotation different from the main axis of rotation and having a housing part mounted to the rotating body and in fluid communication with the supply line, a plurality of nozzle devices and securing members for securing a corresponding one of the nozzle devices to the housing part. Each nozzle device has a nozzle insert with a discharge orifice for dispensing the cleaning fluid and a flow guide part for guiding the cleaning fluid from the housing part to the discharge orifice. The nozzle insert is at least in part releasably received in the securing member and/or the housing part. The securing member is configured to be in detachable engagement with the housing part.

### CROSS-REFERENCE TO RELATED APPLICATION

This application claims priority to German Application No. 102025108580.3, filed on Mar. 6, 2025, the entire disclosure of which is incorporated by reference in its entirety.

### FIELD

The invention relates to a tank cleaner, in particular orbital cleaner, for cleaning a tank. The tank cleaner comprises a static body configured for coupling with a supply line for receiving a cleaning fluid and a rotating body rotatable about a main axis of rotation mounted on the static body. The tank cleaner further comprises a nozzle carrier rotatable about a sub-axis of rotation which is different from the main axis of rotation. The nozzle carrier has a housing part mounted to the rotating body which is in fluid communication with the supply line for receiving the cleaning fluid, a number of nozzle devices for discharging cleaning fluid and a corresponding number of securing members. Each nozzle member is configured for securing a corresponding one of the nozzle devices to the housing part. Further, each nozzle device has a nozzle insert with a discharge orifice for dispensing the cleaning fluid into the tank and a flow guide part for guiding the cleaning fluid from the housing part to the nozzle insert toward the discharge orifice.

### BACKGROUND

In the field of tank cleaning, it is common to utilize mechanical cleaning devices to enable the thorough removal of residues and contaminants from the interior surfaces of tanks. These devices are essential in industries such as food and beverage, pharmaceuticals, and chemicals, where maintaining a high standard of cleanliness is critical. Known systems typically involve the use of rotating nozzle devices mounted to a nozzle carrier that dispense cleaning fluids under relatively high pressure up to 20 bar to dislodge and remove unwanted materials. In that regard, the size and also the configuration of the discharge orifice of the nozzle insert determine the spray performance.

These systems often rely on complex mechanical assemblies to ensure the fluid reaches all necessary areas within the tank, and they must be robust enough to withstand the harsh conditions often encountered in industrial environments. Additionally, the materials used in these systems must be carefully selected to resist corrosion and wear, which can be exacerbated by the high-pressure fluid flow and the chemical nature of the cleaning agents. This often necessitates the use of expensive materials or coatings for the external components of the tank cleaner, driving up the cost of these systems. For example, securing members and housing parts are generally formed from metal material to resist corrosion and wear ensuring a reliable fixation of the nozzle device. Such a securing member may be realized by a closure member receiving the nozzle device at least partly or by a locking means, e.g. a pin, securing the nozzle device by means of a form fit engagement, wherein the nozzle device is protected by the housing part itself.

In order to resist the high-pressure fluid flow and avoid undesired friction and noise due to vibration, the nozzle device is permanently secured to a part of the nozzle carrier in which it is received and protected, such as the securing member configured as a closure member, e.g. by a press fit, to enable a reliable assembly of the metal parts.

Despite the utility of these systems, they present several challenges. One significant issue is the adaption of the spray performance. Many known systems are limited in their ability to adjust the spray performance to accommodate different cleaning requirements. This lack of flexibility can result in inefficient cleaning, where certain areas of the tank may be over-cleaned while others are insufficiently addressed.

In general, replacement of the nozzle device allows the adaption of the spray performance. Thus tank cleaning systems are know that allow replacement of the nozzle device, as disclosed in EP 4 017 644 B1. However, in known systems with removable nozzle devices, the nozzle devices are permanently affixed to the securing member which leads to increased costs for replacement of the nozzle device.

Despite the substantial advances in the field of tank cleaning, there remains a need for improvements that address these issues. Specifically, there is a demand for systems that offer easier and more cost effective adaption of the spray performance. Such improvements would not only reduce operational costs and downtime but also enhance the overall effectiveness and reliability of tank cleaning operations.

It is therefore a technical problem underlying the present invention to provide a tank cleaning system that at least partially overcomes the disadvantages of known systems.

### SUMMARY

It is an object of this invention to provide a tank cleaner that overcomes one or more of the disadvantages of known systems.

These objects are addressed according to an embodiment of the application.

In particular, this object is addressed by a tank cleaner, specifically an orbital cleaner, designed for efficient tank cleaning. The tank cleaner comprises a static body configured to couple with a supply line to receive cleaning fluid, allowing a stable and reliable connection. A rotating body, mounted on the static body, rotates about a main axis of rotation, facilitating comprehensive cleaning coverage. A nozzle carrier rotates around a sub-axis, which is distinct from the main axis. The nozzle carrier includes a housing part attached to the rotating body and is connected to the supply line to receive the cleaning fluid. It also includes multiple nozzle devices and corresponding securing members, each securing a nozzle device to the housing part. Each nozzle device features a nozzle insert with a discharge orifice for releasing or discharging the cleaning fluid into the tank and a flow guide part to direct the fluid from the housing part to the discharge orifice. The discharge orifice is thus the part of the nozzle device from which the cleaning fluid leaves the tank cleaner and from which it is distributed in the tank. In other words, the nozzle insert with its discharge orifice is configured to form a cleaning jet dispensed into the tank. Accordingly, the discharge orifice is the component of the nozzle device that determines the spray performance by its size and geometric configuration.

The static body serves as a stable base that connects to the fluid supply. The rotating body allows for movement around a central axis, enabling the cleaner to cover a larger area within the tank. The nozzle carrier's rotation around a sub-axis being different from the main axis allows an even distribution of the cleaning fluid within the tank. The advantages of this configuration thus include enhanced cleaning efficiency due to the dual-axis rotation, which allows for thorough coverage of the tank's interior surfaces.

In nozzle carriers, the housing part serves as a conduit for the cleaning fluid. Nozzle devices are the components that actually dispense the fluid, and the securing members secure these devices in place. The securing members are therefore connected to the housing in a non-fluid-conducting manner. However, it shall be understood that the securing member may enclose components such as the nozzle insert that are connected to the housing in a fluid-conducting manner. The nozzle insert is the part of the nozzle device that directs the fluid through the discharge orifice. The flow guide part may ensure that fluid is efficiently directed from to the orifice. It shall be understood that the flow guide part and the nozzle insert are either configured as two separate parts or formed as an integral part.

The initially mentioned object may be solved in a first aspect by in that the nozzle insert is at least in part releasably received in the securing member and/or the housing part, wherein the securing member is configured to be in detachable engagement with the housing part. Thereby, the nozzle insert is releasably received and enclosed in a protecting manner by the securing member and/or the housing part and thus is secured in place by detachable engagement of securing member and the housing part. As such, there is no need for the nozzle insert to have any mounting interfaces to be secured to the housing. In other words, the nozzle insert has a mounting-interface-free surface and hold in position only by being received in-between the securing member and the housing part and therefore enclosed. The detachable nature of the nozzle insert and closure member facilitates easy replacement of the whole nozzle device or at least the nozzle insert, wherein the securing member and the housing part may be continuously used. This may reduce downtime and reduce the costs for adapting the spray performance by a continuous use of the expensive securing member and housing part with different nozzle devices, in particular with different nozzle inserts. The inventors recognized that detachable receiving the nozzle device by the securing member and/or the housing part allows sufficient securement and protection of the nozzle device in working conditions. Moreover, by allowing separate replacement of the nozzle device, a greater flexibility in material design may be provided, since the securing member and/or the housing part receiving and protecting the nozzle device may be designed more robust for a continuous use, wherein the nozzle devices which is protected by the securing member may be formed from a less robust and thus cheaper material. In particular, such a securing member may be configured as a nozzle closure member at least partly receiving the nozzle insert and being configured for engagement with the housing part.

It shall be understood that the nozzle insert and the flow guide can either be formed as an integral part or be defined by to separate part. When having the nozzle insert and the flow guide as separate parts, the flow guide can either be arranged at a distance to the nozzle insert or be in direct contact with the nozzle insert.

Further embodiments of the invention are given in the dependent claims, which further develop the concept of the invention with regard to advantageous features in the context of the object of the invention and with regard to further advantages.

In a first embodiment, the nozzle device is at least partly formed by a polymer material. In some embodiments, the nozzle insert and the flow guide part are formed by a polymer material. The nozzle device includes the nozzle insert and the flow guide part, wherein at least one of them is at least partly formed by the polymer material. The introduction of polymer material as a construction element for these components may provide several advantages to the tank cleaner. Polymers may provide a weight reduction compared to traditional metal components, which can improve the ease of handling and installation of the tank cleaner. The use of polymer materials may also offer manufacturing advantages, such as cost-effectiveness and the ability to mold complex shapes with high precision, which can enhance the performance characteristics of the nozzle insert and flow guide part. Moreover, forming the nozzle insert and/or the flow guide part from polymer material may improve the flow characteristics of the cleaning fluid by reducing the flow resistance. The nozzle insert, being formed of polymer, is still designed to be at least in part releasably received in the securing member and/or the housing part, maintaining the detachable engagement with the housing part. This may allow the functional integrity and operational efficiency of the tank cleaner to be preserved while leveraging the benefits of polymer materials. The flow guide part, alternatively or additionally formed of polymer, continues to guide the cleaning fluid from the housing part to the discharge orifice, allowing a consistent and directed flow of cleaning fluid. The material composition does not alter the fundamental communication mechanisms between these components but enhances their efficiency, and their cost-effectiveness. Moreover, forming the nozzle insert from polymer material allows self-sealing of the nozzle insert at the respective contact region with the securing member and/or the housing part in which it is received thereby providing an outer seal of the nozzle device. Moreover, forming the flow guide part from polymer material allows self-sealing of flow guide part with the housing part of the nozzle carrier at the respective contact region thereby providing an inner seal of the nozzle device. Moreover, the use of polymer material, with or without filler materials, allows advanced manufacturing technologies that allow manufacturing of more complex parts, as for example injection molding or 3D-printing. The introduction of polymer materials in these specific parts of the nozzle device thus brings a significant improvement in terms of material properties and manufacturing advantages while maintaining the essential functional characteristics of the tank cleaner.

In a further embodiment, the nozzle insert and the flow guide part are integrally formed. This means that the nozzle insert and the flow guide part are manufactured as a single, unified piece rather than as separate components that are later assembled. This integral formation may provide several advantages to the tank cleaner. Firstly, it may simply the overall design and manufacturing process by reducing the number of separate parts that need to be produced and assembled. This can lead to a reduction in manufacturing costs and potential points of failure. Secondly, the integral formation may enhance the structural integrity and durability of the nozzle insert and flow guide part. By being a single piece, the risk of misalignment or improper fitting during assembly may be eliminated, allowing consistent performance and reliability. Additionally, this design can improve the fluid dynamics within the nozzle, as there are no seams or gaps that could disrupt the flow of the cleaning fluid. This can result in a more efficient and effective cleaning process, as the fluid is guided smoothly from the housing part to the discharge orifice.

In a further embodiment, the nozzle device has an external stop shoulder and the housing part has at least one receiving space with a mating internal stop shoulder. The internal stop shoulder axially secures the nozzle device in a mounting position in which the nozzle device is secured within the receiving space by the securing member being in engagement with the housing part. The external stop shoulder on the nozzle device and the mating internal stop shoulder within the receiving space of the housing part may work together to properly align the nozzle device and hold the nozzle device in place during operation. This axial securing mechanism may prevent undesired movement or dislodgement of the nozzle device, which could otherwise compromise the cleaning efficiency or cause damage to the tank cleaner. The engagement of the securing member with the housing part further reinforces this secure positioning, providing an additional layer of stability and reliability. This feature brings the advantage of easy assembly and disassembly of the nozzle device, facilitating maintenance and replacement without requiring complex tools or procedures. It may also maintain the nozzle device firmly in place during the cleaning process, thereby maintaining consistent performance and reducing the risk of operational failures.

In a further embodiment, the housing part has a housing seal surface and the nozzle device extends in an axial direction and has a bottom seal surface directed in the axial direction which sealingly rests against the housing seal surface. The housing part is described as having a housing seal surface, while the nozzle device extends in an axial direction and features a bottom seal surface that is directed towards the housing seal surface. This bottom seal surface is designed to sealingly rest against the housing seal surface. This configuration may enable a precise alignment and sealing engagement between the nozzle device and the housing part, which allows the cleaning fluid to be properly directed and contained within the desired flow path. The introduction of the housing seal surface and the bottom seal surface may provide an additional seal that prevents undesired ingress of dirt or other substances and cleaning fluid into the housing part of the nozzle carrier. Furthermore, this feature could simplify maintenance and assembly processes, as the sealing surfaces provide a clear point of engagement that can be easily inspected and maintained. The presence of a defined seal surface on both the housing part and the nozzle device suggests that the design is intended to accommodate variations in pressure or flow rates of the cleaning fluid, as the seal would help maintain a consistent flow path under different operating conditions.

In a further embodiment, the flow guide part defines a flow channel extending from a bottom end which defines an inlet orifice to the nozzle insert. The bottom seal surface is arranged at a distance to the bottom end such that the flow channel extends beyond the bottom seal surface into the housing part. The flow guide part is responsible for defining a flow channel, which may direct the cleaning fluid from the housing part to the discharge orifice. The bottom end, which defines an inlet orifice, serves as the entry point for the cleaning fluid into the nozzle insert. The bottom seal surface, positioned at a distance from the bottom end, allows that the flow channel to extend beyond it into the housing part, thereby providing an increased length of the flow channel which may be beneficial in terms of flow characteristics of the cleaning fluid. This arrangement ensures that the cleaning fluid is efficiently guided through the flow channel, from the inlet orifice at the bottom end, past the bottom seal surface, and into the housing part, ultimately reaching the discharge orifice for effective dispensing.

In a further embodiment, the bottom seal surface is provided at the external stop shoulder. The bottom seal surface being located at the external stop shoulder may permit a more secure and reliable sealing arrangement, which can prevent leakage of the cleaning fluid or ingress of dirt or other substances and ensure that the fluid is directed precisely through the discharge orifice. This configuration can also facilitate easier maintenance and replacement of the nozzle insert, as the external stop shoulder provides a clear and accessible point for engaging and disengaging the securing member. By incorporating the bottom seal surface at the external stop shoulder, the nozzle insert may remain firmly in place during operation, thereby maintaining consistent performance and efficiency of the tank cleaner.

In a further embodiment, the nozzle insert has an internal tapered region. In some embodiments, the internal tapered region partly defines a flow channel inside the nozzle insert and tapers towards the discharge orifice. The tapered region serves to streamline the flow of the cleaning fluid, increasing the velocity of the fluid as it exits the discharge orifice. This enhances the cleaning effectiveness by allowing the fluid to be projected with greater force or precision onto the surfaces being cleaned. The tapered region of the nozzle insert is a modification that does not alter the fundamental communication mechanism between the nozzle insert, the securing member, and the housing part but rather enhances the functionality of the nozzle insert itself. By tapering towards the discharge orifice, the nozzle insert facilitates a more controlled and directed flow of cleaning fluid, which can be particularly beneficial in applications where precise cleaning is required. In particular, when formed by a polymer material, manufacturing of the tapered region may be simplified.

In a further embodiment, the securing member is configured as a closure member receiving the nozzle insert. Further preferred, the securing member has a distal stop shoulder, preferably protruding radially inwards, wherein a front end of the nozzle device which surrounds the discharge orifice sealingly rests against the distal stop shoulder. The distal stop shoulder preferably projects inwards and serves as a precise positioning means which may correctly align the nozzle device and securely hold the nozzle device in place when engaged with the securing member. The front end of the nozzle device, which surrounds the discharge orifice, is designed to sealingly rest against this distal stop shoulder, thereby creating a reliable seal that prevents leakage of the cleaning fluid during operation. This sealing engagement may maintain the efficiency and effectiveness of the cleaning process, as it may allow the cleaning fluid to be directed precisely through the discharge orifice, while ingress of dirt or other substances from the tank is avoided. Additionally, this feature may simplify the assembly and disassembly process, as the nozzle device can be easily and accurately positioned within the securing member, facilitating maintenance and replacement of the nozzle devices.

In a further embodiment, the housing part has a number of mounting recesses, wherein from each one mounting recesses a receiving space extends into the housing body. Further preferred, each mounting recess has a mounting thread configured to engage with a closure thread of the securing member for releasably securing the nozzle device to the body part. This feature may enable a secure and detachable connection between the nozzle device and the housing part, enhancing the modularity and maintenance ease of the tank cleaner. Preferably, the securing member further has a bottom face at a distance to the closure thread in the axial direction, which is received within the receiving space. This design element provides a more stable and precise alignment of the securing member within the housing part, allowing the nozzle device to be securely held in place during operation. The introduction of mounting threads and closure threads for securing the nozzle device to the housing part allows for a more robust and reliable connection, which may be beneficial for the effective operation of the tank cleaner. The detachable engagement mechanism provided by the mounting threads and closure threads may allow the nozzle devices to be easily replaced or serviced without requiring extensive disassembly of the entire nozzle carrier. This modular approach to the design of the tank cleaner may not only improves its maintainability but also allow for greater flexibility in configuring the cleaner for different cleaning tasks.

In a further embodiment, the securing member and the nozzle device are formed from different materials. This differentiation in material composition may be a significant feature that brings several advantages. By specifying that the securing member and the nozzle device are formed from different materials, the embodiment highlights a thoughtful design consideration that balances the need for strength and durability with the benefits of corrosion resistance and weight reduction. This feature can improve the longevity and reliability of the tank cleaner, making it more suitable for a wide range of cleaning applications. The use of different materials also allows for the possibility of customizing the tank cleaner for specific cleaning tasks, where the properties of the materials can be selected to match the requirements of the cleaning fluid and the environment. The securing member is preferably formed by a metal material, while the nozzle device is preferably formed at least partly by a polymer material. The metal material used for the securing member provides robustness and strength, allowing a secure and stable attachment to the housing part. This may maintain the integrity of the connection under the pressure of the cleaning fluid. On the other hand, the polymer material used for the nozzle device offer benefits in terms of flow characteristics and manufacturability. Additionally, the polymer material may contribute to a reduction in weight, which can facilitate easier handling. The combination of these materials can also lead to a more cost-effective manufacturing process, as polymers are generally less expensive than metals and can be molded into complex shapes with relative ease.

In a further embodiment, the nozzle insert and the flow guide part are both at least in part releasably received in the securing member. Thus, in addition to the nozzle insert also the flow guide part is at least in part releasably received in the securing member, which is configured to be in detachable engagement with the housing part. This configuration may enhance the adaptability of the spray performance by allowing easy replacement of the flow guide part in addition to the nozzle inlet. This feature may thus allows for greater flexibility in the design and customization of the nozzle device, as different nozzle inserts and flow guide parts can be easily interchanged to suit specific cleaning performance requirements.

In a further embodiment, the tank cleaner further comprises an outer nozzle seal received between the securing member and the housing part. The introduction of an outer nozzle seal received between the securing member and the housing part provides an additional sealing mechanism, allowing the cleaning fluid to be effectively contained within the nozzle assembly and preventing leaks. Additionally, the ingress of dirt or other substances from the tank may be avoided. This feature may enhance the reliability and efficiency of the tank cleaner by maintaining a consistent flow of cleaning fluid through the nozzle devices.

In a further embodiment, the housing part comprises a central bore configured for engaging a gear member of the rotating body, wherein a central stop shoulder surrounds the central bore. The central bore is configured for receiving at least one central seal ring, in particular a first central seal ring resting against a first axially facing side of the centrals stop shoulder and a second central seal ring resting against an opposite axially facing side of the central stop shoulder. The central bore allows for precise alignment and rotation of the nozzle carrier. This arrangement of seal rings may provide a robust sealing mechanism that enhances the durability and performance of the tank cleaner. The seal rings may prevent fluid leakage along the central bore of the nozzle carrier.

The subject matter of the instant application may solve the initially mentioned object in a second aspect. The nozzle device is adapted to be used in a tank cleaner, in particular in a tank cleaner according to the first aspect. In particular, the nozzle device is configured for being secured to a housing part of a nozzle carrier of the tank cleaner by a corresponding securing member. The nozzle device has a nozzle insert with a discharge orifice for dispensing the cleaning fluid into a tank and a flow guide part for guiding the cleaning fluid from the housing part to the nozzle insert, and thus in particular toward the discharge orifice. The nozzle insert is configured for being at least in part releasably received in the securing member. By suggesting that nozzle insert is configured for being at least in part releasably received in the securing member, the nozzle device has the same benefits as described with regard to the first aspect of the invention. Thus, benefits and preferred embodiments of the first aspect of the invention may be at the same time benefits and preferred embodiments of the second aspect of the invention.

The subject matter of the instant application may solve the initially mentioned object in a third aspect. In particular, the invention suggests a method for manufacturing a nozzle device for a tank cleaner, in particular for manufacturing a nozzle device according to the second aspect of the invention. The method comprises the steps:
providing a base material,
melting the base material, and
near-net-shape production of a nozzle device with a nozzle insert and a flow guide part with an internal flow channel from the molten base material. In other words, the method begins with providing a base material, which is then melted to form a molten base material. This molten base material is subsequently used in a near-net-shape production process to create the nozzle device. The nozzle device produced through this method comprises a nozzle insert and a flow guide part, which includes an internal flow channel. This process may allow the nozzle insert and the flow guide part, including the internal flow channel, to be integrally formed from the molten base material. The new features introduced by this method bring several advantages. By utilizing a near-net-shape production process, the method enhances the precision and efficiency of manufacturing the nozzle device, reducing the need for extensive post-processing and material wastage. The integration of the nozzle insert and the flow guide part with the internal flow channel in a single production step may further allow a seamless and robust construction, improving the overall performance and reliability of the nozzle device. Additionally, the method may allow for greater design flexibility, enabling the creation of complex geometries and internal structures that optimize the flow of cleaning fluid through the nozzle device and that generally cannot be manufactured with grinding or the like. This may result in improved cleaning efficiency and effectiveness when the nozzle device is used in the tank cleaner.

In a further embodiment the near-net-shape production for the nozzle device involves applying the base material through additive manufacturing, specifically 3D-printing, or by injection molding to form the near-net-shaped nozzle device. Additive manufacturing, particularly 3D-printing, may allow for precise control over the geometry and material properties of the nozzle device, enabling the production of complex shapes and internal structures that may not be achievable through traditional manufacturing methods. This can result in improved performance characteristics, such as optimized fluid flow paths and enhanced durability. Injection molding, on the other hand, may offer the advantage of high-volume production with consistent quality, making it suitable for mass production of the nozzle devices.

The invention solves the initially mentioned object in a third aspect by a method for adapting the spray performance of a tank cleaner. The method comprises in a first step adapting the spray performance of a tank cleaner involves disengaging a securing member from a housing part of a nozzle carrier, which allows for altering the spray characteristics. This disengagement allows for the removal of at least a first nozzle insert or the entire first nozzle device from a receiving space that extends from a mounting recess into the housing part. This interchangeability is a key feature, as it allows for the customization of the tank cleaner's spray performance by varying the nozzle inserts or devices. The method further includes the step of detachably engaging the securing member with the housing part of the nozzle carrier, thereby securing the newly inserted nozzle insert or device in place. The detachable engagement may allow the nozzle device to remain securely attached during operation while still allowing for easy removal and replacement when necessary. The method offers the ability to adapt the spray performance by using a second nozzle insert with a discharge orifice that has a different diameter than the first nozzle device's discharge orifice. This variation in diameter directly affects the flow rate and spray pattern of the cleaning fluid, enabling the tank cleaner to be tailored to specific cleaning requirements. By allowing for the replacement of nozzle inserts with different diameters, the method provides a flexible and efficient means of optimizing the cleaning process for different tank configurations or levels of contamination. The communication between the components, namely the securing member, the housing part, and the nozzle inserts or devices, is facilitated through the detachable engagement and the receiving space, which together enable the seamless interchange of nozzle components to achieve the desired spray performance.

### BRIEF DESCRIPTION OF THE DRAWINGS

The present disclosure will be explained in more detail, by way of example, with reference to the drawings in which:

FIG. 1: shows an embodiment of a tank cleaner with a static body, rotating body, nozzle carrier, and securing members;

FIG. 2: shows an exploded view of a nozzle carrier assembly with its various components;

FIG. 3: shows the nozzle carrier according to FIG. 2 in a front view;

FIG. 4: shows the nozzle carrier according to FIG. 2 in a sectional side view;

FIG. 5: shows the nozzle carrier according to FIG. 2 in a sectional front view;

FIG. 6: shows a detailed cross-sectional view of a nozzle device secured within the housing part;

FIG. 7: shows a schematic flowchart of a method for manufacturing a nozzle device;

FIG. 8: shows a schematic flowchart of a method for adapting the spray performance of a tank cleaner.

### DETAILED DESCRIPTION

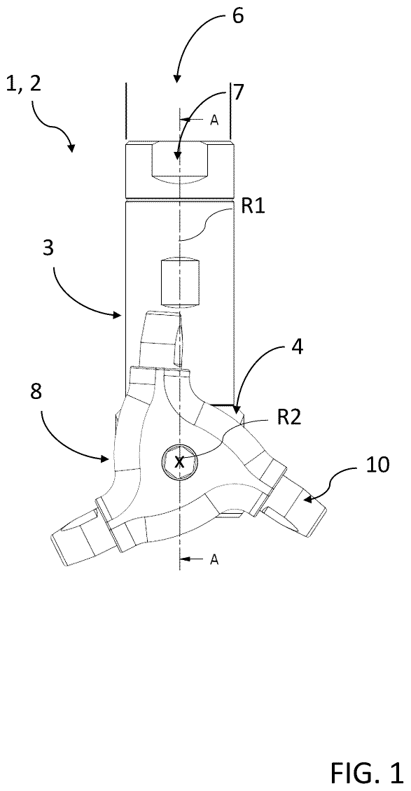

FIG. 1 illustrates a tank cleaner 1, specifically an orbital cleaner 2, designed for cleaning a tank.

The tank cleaner 1 comprises a static body 3, a rotating body 4 and a nozzle carrier 8. The static body 3 is configured for coupling with a supply line 6 to receive cleaning fluid. An adapter 7 associated to the static body 3 may be also provides for coupling the supply line 6 to the static body.

The rotating body 4 is mounted on the static body 3 and rotates about a main axis of rotation R1. This rotational capability allows the rotating body 4 to perform cleaning operations within the tank by distributing the cleaning fluid in a controlled manner. The rotating body 4, which is mounted on the static body 3, rotates about the main axis of rotation R1, wherein the nozzle carrier 8 is supported by the rotating body 4 rotatable around a secondary axis of rotation R2. The sub-axis of rotation R2 is distinct from the main axis of rotation R1.

The nozzle carrier 8, which rotates about a sub-axis of rotation R2, is mounted on the rotating body 4. The nozzle carrier 8 is equipped with multiple nozzle devices (not shown) for dispensing the cleaning fluid, each secured by a corresponding securing member 10 which is configured as a nozzle closure member in the shown embodiment.

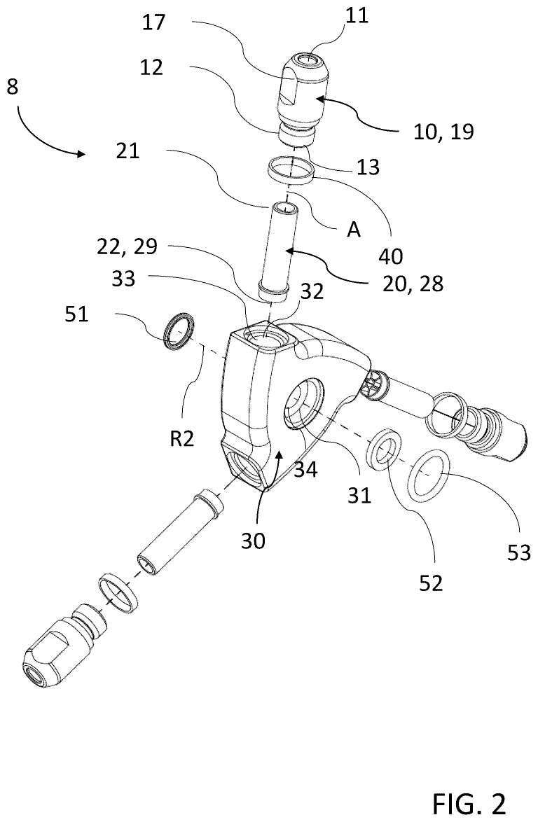

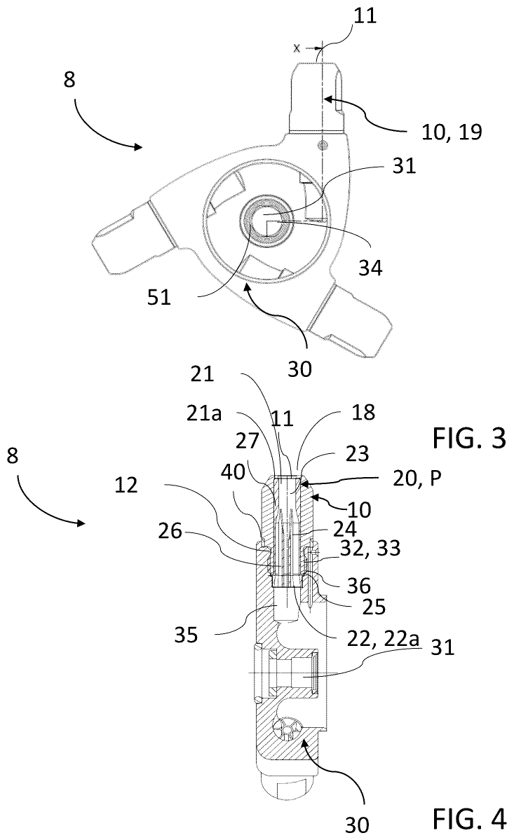

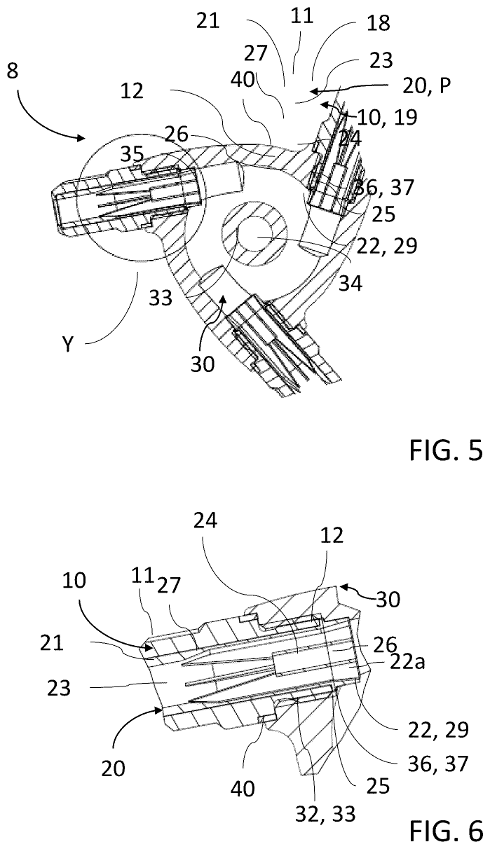

FIG. 2 to FIG. 5 illustrate a nozzle carrier 8 for a tank cleaner 1. The nozzle carrier 8 comprises various components, including a securing member 10, a nozzle device 20, and a housing part 30. The securing member 10 includes a closure thread 12. The securing member 10 is designed to engage with the housing part 30, which features a mounting thread 33 corresponding to the closure thread 12. The housing part 30 defines a receiving space 35 for receiving a respective one of the nozzle devices 20.

The nozzle device 20, preferably formed at least partly by a polymer material 28, includes a nozzle insert 23 with a discharge orifice 21 and a flow guide part 24. The nozzle insert 23 is configured such that at least a part of it is releasably received in the securing member 10. However, in alternative embodiments the nozzle insert 23 may be only received in the housing part 30 and secured by the securing member 10 in place which may be configured as a locking member for a form-fit engagement, e.g. a pin.

The nozzle device 20 further comprises an external stop shoulder 25 and a bottom seal surface 29. The bottom seal surface 29 is directed in the axial direction A and is designed to sealingly rest against a housing seal surface (see FIG. 6) of the housing part 30. The flow guide part 24 defines a flow channel 26 extending from a bottom end 22, which defines an inlet orifice 22a, to the nozzle insert 23. The bottom seal surface 29 is arranged at a distance to the bottom end 22, such that the flow channel 26 extends beyond the bottom seal surface 29 into the housing part 30.

The housing part 30 comprises a central bore 31 configured for engaging a gear member of the rotating body 4. A central stop shoulder 34 surrounds the central bore 31. The central bore 31 is configured for receiving at least one central seal ring, specifically a first central seal ring 51 resting against a first axially facing side of the central stop shoulder 34, and a second central seal ring 53 resting against an opposite axially facing side of the central stop shoulder 34. A securing device 52 may be arranged between the seal rings 53, 55 to support positioning of a drive shaft (not shown) for driving to nozzle carrier 8.

Additionally, the assembly includes an outer nozzle seal 40 received between the securing member 10 and the housing part 30. The securing member 10 further has a bottom face 13 at a distance to the closure thread 12 in the axial direction A, which is received within the receiving space 35. The securing member 10 is designed to be in detachable engagement with the housing part 30, allowing for easy replacement or maintenance of the nozzle device 20.

The nozzle insert 23 has an internal tapered region 27 which partly defines the flow channel 26. The tapered region 27 tapers towards the discharge orifice 21, enabling a focused and efficient spray pattern for cleaning the tank. The housing part 30 also has a number of mounting recesses 32 from which the receiving space 35 extends into the housing body 30. Each mounting recess 32 is configured to engage with the closure thread 12 of the securing member 10 for releasably securing the nozzle device 20 to the housing part 30.

FIG. 6 provides a detailed sectional view of the nozzle device 20 which is inserted into the housing part 30. As described with regard to FIG. 2 to FIG. 5, the nozzle device 20 includes a flow guide part 24, which defines a flow channel 26 extending from a bottom end 22 with an inlet orifice 22a to the nozzle insert 23. The bottom seal surface 29 of the nozzle device 20 is arranged at a distance from the bottom end 22, allowing the flow channel 26 to extend beyond the bottom seal surface 29 into the housing part 30.

The securing member 10 is depicted with a distal stop shoulder 18, against which the front end 21a of the nozzle device 20, surrounding the discharge orifice 21, sealingly rests. An outer nozzle seal 40 is positioned between the securing member 10 and the housing part 30, further enabling a secure and leak-proof connection.

The housing part 30 is shown to have a housing seal surface 37, against which the bottom seal surface 29 of the nozzle device 20 sealingly rests. This arrangement may allow the cleaning fluid to be guided efficiently from the housing part 30 through the flow guide part 24 and out of the discharge orifice 21.

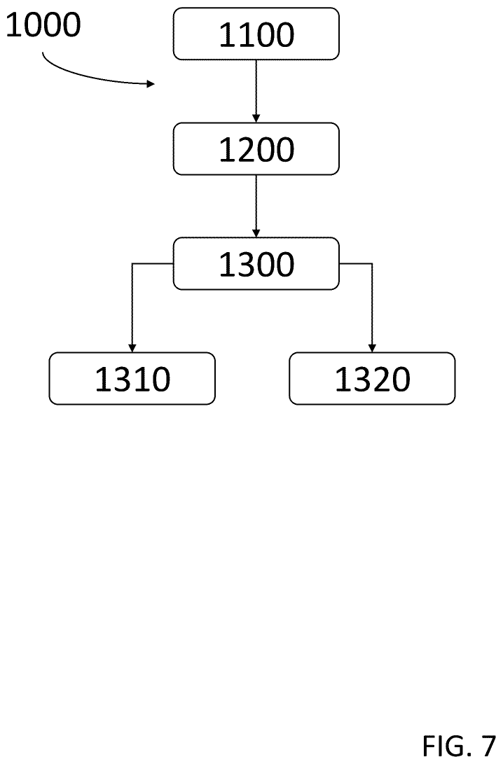

FIG. 7 illustrates a flowchart depicting a method 1000 for manufacturing a nozzle device 20 as shown in FIG. 2 to FIG. 5 for a tank cleaner 1. The method begins with step 1100, which involves providing a base material 28a. This step is followed by a second step 1200, in which the base material 28a is melted.

Subsequently, the process advances to a third step 1300, which entails the near-net-shape production of a nozzle device 20 from the molten base material 28a. The nozzle device 20 comprises a nozzle insert 23 and a flow guide part 24 with an internal flow channel 26.

Step 1300 preferably branches into two alternative sub-steps. The first sub-step 1310 involves applying the base material 28 a by additive manufacturing, specifically by 3D-printing, to form the near-net-shaped nozzle device 20. Alternatively, the second sub-step 1320 involves applying the base material 28a by injection molding to form the near-net-shaped nozzle device 20.

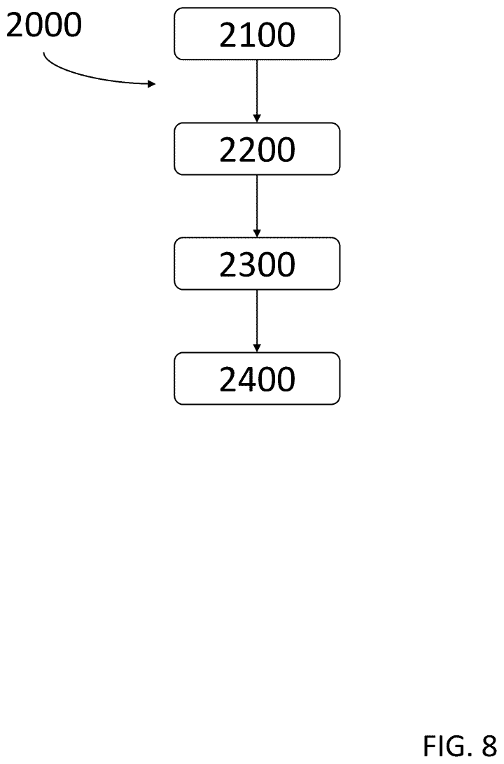

FIG. 8 illustrates a flowchart depicting a method 2000 for adapting the spray performance of a tank cleaner 1 as illustrated in FIG. 1. The method 2000 begins with step 2100, which involves disengaging a securing member 10 from a housing part 30 of a nozzle carrier 8. This step allows for accessing the internal components of the nozzle carrier 8, in particular to the nozzle device 20. Following this, a second step 2200 entails removing at least a first nozzle insert 23 of a first nozzle device 20 or the first nozzle device 20 as a whole from a receiving space 35 extending from a mounting recess 33 into the housing part 30. This removal process is necessary to facilitate the replacement or adjustment of the nozzle insert 20 to modify the spray characteristics.

Subsequently, step 2300 involves inserting a second nozzle insert 23 of a second nozzle device 20 or the second nozzle device 20 as a whole into the receiving space 35. The second nozzle insert 23 is selected based on the desired spray performance, with a discharge orifice 21 having a second diameter different from the first diameter of the discharge orifice 21 of the first nozzle device 20. This insertion step may allow the new nozzle insert 23 to be properly positioned within the housing part 30 to achieve the intended spray performance and flow rate.

Finally, step 2400 comprises detachably engaging the securing member 10 with the housing part 30 of the nozzle carrier 8. This step secures the newly inserted nozzle insert 23 in place such that it is firmly held within the housing part 30 and ready for operation. The detachable engagement allows for easy future adjustments or replacements of the nozzle insert 23, providing flexibility in adapting the spray performance as needed.

### REFERENCE SIGNS

1 tank cleaner
2 orbital cleaner
3 static body
4 rotating body
6 supply line
8 nozzle carrier
10 securing member
11 distal recess
12 closure thread
13 bottom face
17 engagement surface
18 distal stop shoulder
19 metal material
20 nozzle device
21 discharge orifice
21a front end
22 bottom end
23 nozzle insert
24 flow guide part
25 external stop shoulder
26 flow channel
27 tapered region
28 polymer material
29 bottom seal surface
30 housing part
31 central bore
32 number of mounting recesses
33 mounting thread
34 central stop shoulder
35 receiving space
36 mating internal stop shoulder
37 housing seal surface
40 outer nozzle seal
51 first central seal ring
52 securing member
53 second central seal ring
A axial direction
P mounting position
R1 main axis of rotation
R2 sub-axis of rotation

1. A tank cleaner for cleaning a tank, the tank cleaner comprising:
a static body configured for coupling with a supply line for receiving a cleaning fluid;
a rotating body mounted on the static body and rotatable about a main axis of rotation; and
a nozzle carrier rotatable about a sub-axis of rotation, the sub-axis being different from the main axis of rotation, the nozzle carrier having a housing part mounted to the rotating body and being in fluid communication with the supply line for receiving the cleaning fluid, a plurality of nozzle devices for discharging cleaning fluid and a plurality of corresponding securing members each configured to secure a corresponding one of the nozzle devices to the housing part;
wherein each of the nozzle devices has a nozzle insert with a discharge orifice for dispensing the cleaning fluid into the tank and a flow guide part for guiding the cleaning fluid from the housing part to the nozzle insert toward the discharge orifice; and
wherein the nozzle insert of each nozzle device is at least partially releasably received in at least one of the securing member and the housing part, and each securing member is configured to be in detachable engagement with the housing part.

2. The tank cleaner according to claim 1, wherein each of the nozzle devices comprises a polymer material.

3. The tank cleaner according to claim 1, wherein each of the nozzle inserts and the flow guide parts comprise a polymer.

4. The tank cleaner according to claim 3, wherein the nozzle insert and the flow guide part are integrally formed for each nozzle device.

5. The tank cleaner according to claim 1, wherein each of the nozzle devices has an external stop shoulder and the housing part has at least one receiving space with a mating internal stop shoulder, and wherein the internal stop shoulder axially secures each of the nozzle devices in a mounting position and each of the nozzle devices is secured within the receiving space by the securing member being in engagement with the housing part.

6. The tank cleaner according to claim 1, wherein the housing part has a housing seal surface and each of the nozzle devices extends along an axial direction and has a bottom seal surface that faces in the axial direction and is configured to seal against the housing seal surface.

7. The tank cleaner according to claim 6, wherein the flow guide part defines a flow channel that extends from a bottom end, the bottom end defining an inlet orifice to the nozzle insert, and wherein the bottom seal surface is arranged at a distance to the bottom end such that the flow channel extends beyond the bottom seal surface into the housing part.

8. The tank cleaner according to claim 7, wherein the bottom seal surface is disposed at the external stop shoulder.

9. The tank cleaner according to claim 7, wherein the nozzle insert has an internal tapered region that at least partially defines the flow channel and tapers towards the discharge orifice.

10. The tank cleaner according to claim 1, wherein the securing member has a distal stop shoulder, and wherein a front end of the nozzle device, which surrounds the discharge orifice, sealingly rests against the distal stop shoulder.

11. The tank cleaner according to claim 10, wherein the distal stop shoulder protrudes radially inwards.

12. The tank cleaner according to claim 1, wherein the housing part comprises a plurality of mounting recesses from which the corresponding receiving space extends into the housing body, each mounting recess having a mounting thread configured to engage with a closure thread of the securing member for releasably securing the nozzle device to the body part of the tank cleaner.

13. The tank cleaner according to claim 12, wherein the securing member has a bottom face at a distance to the closure thread in the axial direction, the bottom face being received within the corresponding receiving space.

14. The tank cleaner according claim 1, wherein the securing member and the nozzle device are formed from different materials.

15. The tank cleaner according to claim 14, wherein each securing member comprises metal, and each nozzle device comprises a polymer material.

16. The tank cleaner according to claim 1, wherein the nozzle insert and the flow guide part are at least partially releasably received in the securing member, and wherein the securing member is configured to be in detachable engagement with the housing part.

17. A nozzle device for a tank cleaner for cleaning a tank, the nozzle device comprising:
a nozzle insert having a discharge orifice for dispensing a cleaning fluid; and
a flow guide part configured to guide the cleaning fluid from a housing part to the nozzle insert;
wherein the nozzle insert and the flow guide part are at least partially releasably received in a securing member, the securing member being configured to secure the nozzle device to a housing part.

18. A method for manufacturing a nozzle device for a tank cleaner, the method comprising the steps:
providing a base material;
melting the base material;
performing a near-net-shape production of a nozzle device from the molten base material, wherein the nozzle device comprises a nozzle insert and a flow guide part with an internal flow channel.

19. The method according to claim 18, wherein the near-net-shape production comprises at least one of the following steps:
applying the base material by additive manufacturing to form the near-net-shaped nozzle device; and
applying the base material by injection molding to form the near-net-shaped nozzle device.

20. A method for adapting a spray performance of a tank cleaner, the method comprising the steps:
disengaging a securing member from a housing part of a nozzle carrier;
removing at least one of a first nozzle insert of a first nozzle device and the first nozzle device as a whole from a receiving space extending from a mounting recess into the housing part, the first nozzle insert being configured for dispensing a cleaning fluid into a tank;
inserting at least one of a second nozzle insert of a second nozzle device and the second nozzle device as a whole into the receiving space, the second nozzle insert being configured for dispensing the cleaning fluid into the tank;
detachably engaging the securing member with the housing part of the nozzle carrier;
wherein the second nozzle insert has a discharge orifice with a second diameter being different from a first diameter of a discharge orifice of the first nozzle device.
